(19) United States
(12) Patent Application Publication
(10) Pub. No.: US 2026/0352319 A1
(43) Pub. Date: Nov. 5, 2026

(54) SYSTEMS AND METHODS FOR GENERATING SITUATIONAL ASSESSMENTS AND SELECTING COURSES OF ACTION

(71) Applicant: Slingshot Aerospace, Inc., El Segundo, CA (US)

(72) Inventors: Timothy M. Olson, Mahomet, IL (US); Brian R. Williams, San Augustine, TX (US); David R. Witman, Parkton, MD (US); Alexander R. Post, Phoenix, AZ (US); Jordan M. Murphy, Denver, CO (US); Brian Crouse, Walnut Shade, MO (US); Chad A. Bustard, Madison, WI (US); Hari S. Ilangovan, Atlanta, GA (US); Clarice V. Reid, Atlanta, GA (US); Paul M. Diaz, Boulder, CO (US); Dylan C. Kesler, Chesterfield, MO (US); Belinda Marchand, Austin, TX (US)

(21) Appl. No.: 19/665,717

(22) Filed: May 1, 2026

Related U.S. Application Data
(60) Provisional application No. 63/799,132, filed on May 2, 2025.

(51) Int. Cl. H04B 7/185

(52) U.S. Cl. CPC H04B 7/18519

(57) ABSTRACT

A system for selecting a course of action for at least one object in a collection of remote objects (e.g., an orbital object, a controllable vehicle, a satellite) can include sensors for remotely measuring quantitative data associated with the at least one object, a database including qualitative data associated with the at least one object, and a controller. The controller can be configured to receive the quantitative data from the plurality of sensors and receive the qualitative data from the database. The controller can also be configured to mechanistically generate a situational assessment for the at least one object based upon the quantitative data and the qualitative data, mechanistically generate a plurality of courses of action based upon the situational assessment, and mechanistically select a course of action from the plurality of courses of action.

### CROSS-REFERENCE TO RELATED APPLICATIONS

The present application claims the benefit under 35 U.S.C. §119(e) of U.S. Provisional Application Serial No. 63/799,132, filed May 2, 2025, and titled “SYSTEMS AND METHODS FOR GENERATING SITUATIONAL ASSESSMENTS AND SELECTING COURSES OF ACTION,” which is herein incorporated by reference in its entirety.

### BACKGROUND

In computing systems, an agent is generally an entity that perceives an environment, undertakes actions directed toward goals, and improves its performance using machine learning techniques and/or the acquisition of additional knowledge.

### DRAWINGS

The Detailed Description is described with reference to the accompanying figures. The use of the same reference numbers in different instances in the description and the figures may indicate similar or identical items.

FIG. 1 is a diagrammatic illustration of a system for generating a situational assessment for at least one object in a collection of remote objects in accordance with example embodiments of the present disclosure.

FIG. 2A is a diagrammatic illustration of a system for selecting a course of action for at least one object in a collection of remote objects in accordance with example embodiments of the present disclosure.

FIG. 2B is a diagrammatic illustration of another system for selecting a course of action for at least one object in a collection of remote objects in accordance with example embodiments of the present disclosure.

FIG. 3A is a diagrammatic illustration of a further system for selecting a course of action for at least one object in a collection of remote objects in accordance with example embodiments of the present disclosure.

FIG. 3B is another diagrammatic illustration of the system illustrated in FIG. 3A.

FIG. 4 is a diagrammatic illustration of an observe-orient-decide-act (OODA) loop, which can be implemented by a system for selecting a course of action for at least one object in a collection of remote objects in accordance with example embodiments of the present disclosure.

FIG. 5 is a diagrammatic illustration of another observe-orient-decide-act (OODA) loop, which can be implemented by a system for selecting a course of action for at least one object in a collection of remote objects in accordance with example embodiments of the present disclosure.

FIG. 6 is a diagrammatic illustration of a system for synthesizing input data for insights or actions in accordance with example embodiments of the present disclosure.

FIG. 7 is a block diagram illustrating a system for generating a situational assessment for at least one object in a collection of remote objects and/or for selecting a course of action for at least one object in a collection of remote objects in accordance with example embodiments of the present disclosure.

FIG. 8 is a diagrammatic illustration of a collection of satellites in Earth orbit, optical ground stations, and a radar observation station in accordance with example embodiments of the present disclosure.

FIG. 9 is a block diagram illustrating quantitative data for a system that can generate situational assessments and select courses of action for interacting with environments where information can be gathered for collections of remote objects, such the collection of satellites illustrated in FIG. 8, in accordance with example embodiments of the present disclosure.

FIG. 10 is a block diagram illustrating qualitative data for a system that can generate situational assessments and select courses of action for interacting with environments where information can be gathered for collections of remote objects, such the collection of satellites illustrated in FIG. 8, in accordance with example embodiments of the present disclosure.

FIG. 11 is a diagrammatic illustration of a user interface for a system for selecting a course of action for at least one object in a collection of remote objects, where the user interface provides an advisor mode for an operator (e.g., human in the loop) in accordance with example embodiments of the present disclosure.

FIG. 12A is a flow diagram illustrating methods for generating a situational assessment for at least one object in a collection of remote objects in accordance with example embodiments of the present disclosure.

FIG. 12B is a continuation of the flow diagram from FIG. 12A.

FIG. 13A is a flow diagram illustrating methods for selecting a course of action for at least one object in a collection of remote objects in accordance with example embodiments of the present disclosure.

FIG. 13B is a continuation of the flow diagram from FIG. 13A.

FIG. 14A is a flow diagram illustrating methods for generating a situational assessment for at least one object in a collection of remote objects and selecting a course of action for the at least one object in accordance with example embodiments of the present disclosure.

FIG. 14B is a continuation of the flow diagram from FIG. 14A.

FIG. 14C is a continuation of the flow diagram from FIG. 14B.

### DETAILED DESCRIPTION

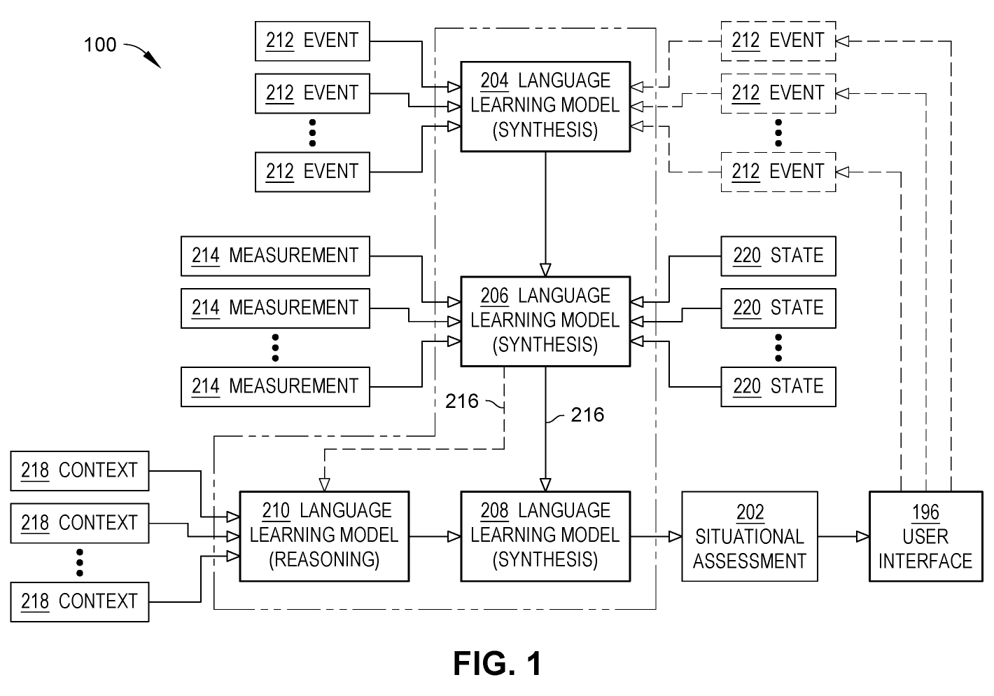

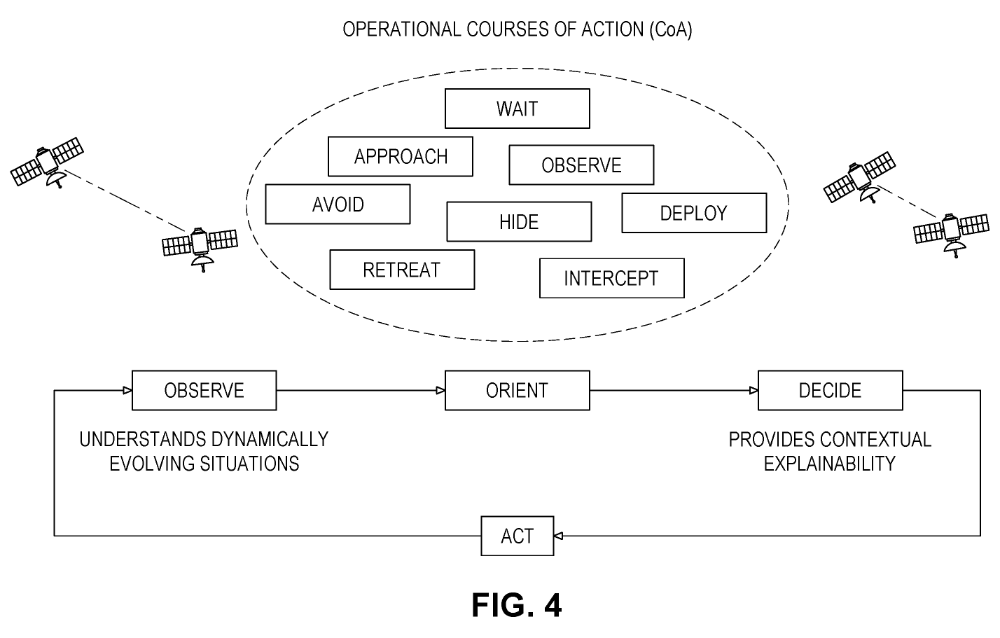

Referring generally to FIGS. 1 through 14C, systems, techniques, and apparatus for generating situational assessments and selecting courses of action are described for interacting with environments where information can be gathered for collections of remote objects. For example, systems are described that can implement thinking agents for logical operations and strategy. For the purposes of the present disclosure, the term “agent” shall be understood to refer to an automated computing system implementation where an environment is perceived, actions directed toward goals are undertaken autonomously, and performance of the system is improved using machine learning techniques and/or the acquisition of additional knowledge.

The systems described herein can provide synthesis and reasoning capabilities, being able to ingest data in a variety of formats and autonomously employ tools, sub-agents, and memory frameworks. The systems can build an understanding of a collection of remote objects and learn from experience. Interactions with the systems can be, at least in part, accomplished via natural language. Generally, the systems, techniques, and apparatus described herein can provide artificial intelligence (AI) agents that perceive a world state, generate candidate courses of action, and use reasoning to interpret mission objectives and select a course of action with human-like explanations.

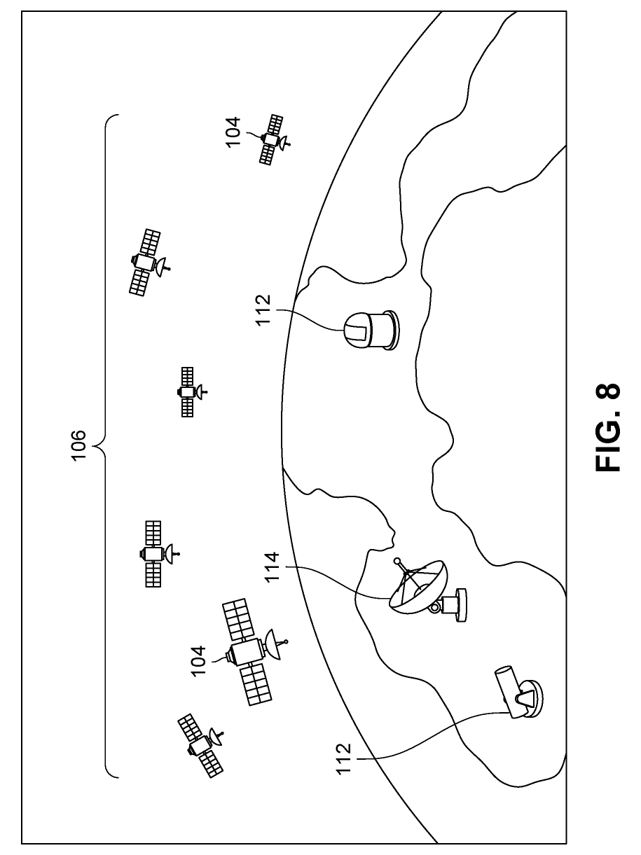

A system 100 for generating a situational assessment for at least one object in a collection of remote objects can include sensors for remotely measuring quantitative data associated with the object. In some embodiments, an object in a collection of remote objects can be an orbital object. In an example, an object can be a controllable vehicle. For example, a system 100 can generate a situational assessment for one or more satellites 104 in a collection 106 of satellites. A system 100 can use sensors at optical ground stations 112, radar observation stations 114, satellites 104, and so on, to remotely measure the quantitative data, e.g., as shown in FIG. 8.

For the purposes of the present disclosure, the term “collection” with respect to the term “object” shall be understood to refer to a group or network of identical or similar-type objects that have shared control or lack thereof, e.g., a collection of artificial objects orbiting the Earth, such as satellites. However, satellites and Earh-orbiting objects are provided by way of example and are not meant to limit the present disclosure. In other embodiments, a collection of objects can be a different collection of objects, such as a collection of autonomous vehicles (e.g., cars, ships, drones), a collection of self-propelled, guided, or ballistic weapons, and so forth.

The term “orbital object” shall be understood to refer to an object that takes a regular repeating path around another object. For example, an orbital object can be a satellite 104, natural debris, space junk, and so forth. The term “satellite” shall be understood to refer to an object that orbits a celestial body, such as the Earth, another planet, a moon, a sun, and so on. Artificial satellites placed into orbit around the Earth can be used in applications including communication relay, weather forecasting, navigation (e.g., global positioning system (GPS) applications), broadcasting, scientific research, Earth observation, and so forth. A collection 106 of satellites 104 may be described with reference to a constellation of satellites, a swarm of satellites, and so on. In some embodiments, a collection of satellites can be a grouping of low Earth orbit (LEO) satellites, a grouping of medium Earth orbit (MEO) satellites, a grouping of geostationary/geosynchronous equatorial orbit (GEO) satellites, and so forth. The systems, techniques, and apparatus described herein can be used for sensor tasking and scheduling, e.g., for satellite tracking and/or other geospatial applications.

For the purposes of the present disclosure, the term “quantitative data” with respect to an object shall be understood to refer to information about the object that is expressed in terms of a numerical quantity (e.g., speed), a direction (e.g., North by Northwest), or other measurable characteristics expressing the relationship between the object and its environment. For example, quantitative data can include photometric observations, radar observations, and data from other sensor modalities and/or data streams.

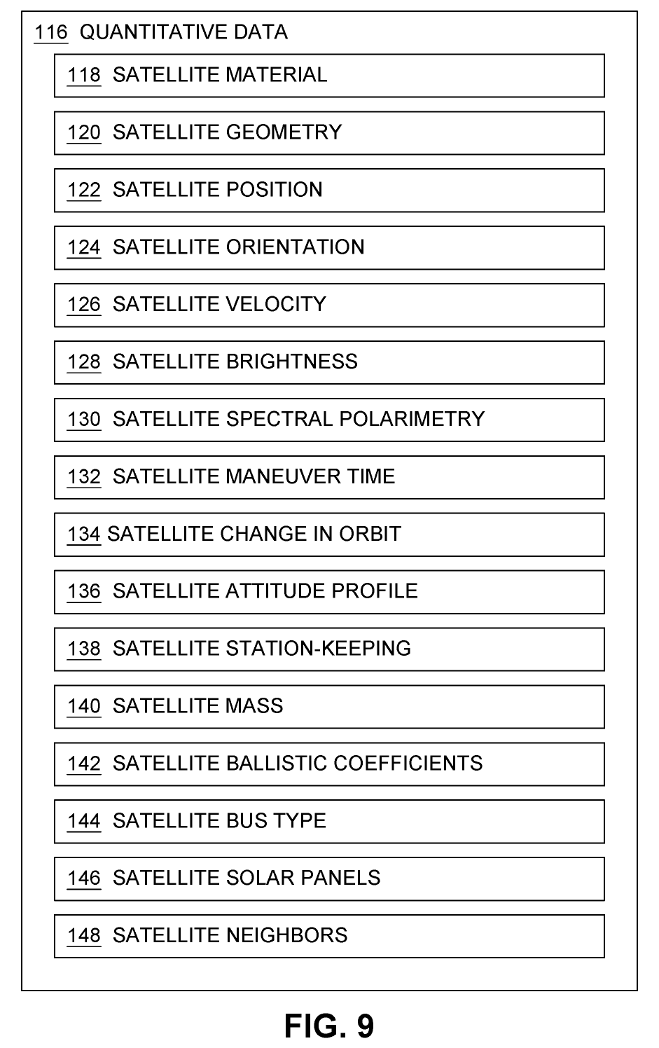

Referring now to FIG. 9, examples of quantitative data 116 can include, but are not necessarily limited to: satellite material 118, satellite geometry 120, satellite position 122, satellite orientation 124, satellite velocity 126, satellite brightness 128, satellite spectral polarimetry 130, satellite maneuver time 132, satellite change in orbit 134, satellite attitude profile 136, satellite station-keeping 138, satellite mass 140, satellite ballistic coefficients 142, satellite bus (body) type 144, satellite solar panels 146, satellite neighbors 148, and so forth. Measurement devices for obtaining quantitative data 116 can include, but are not necessarily limited to, optical ground stations 112, radar observation stations 114, space-based observation stations (e.g., satellites 104), and so forth, e.g., as described with reference to FIG. 8. For example, a satellite 104 may have a camera for tracking stars, and information about other satellites may also be remotely collected by the satellite 104 using its camera. In some embodiments, quantitative data 116 can include publicly available information, such as open-source intelligence (OSINT) information. Examples of such publicly available information can include, but are not necessarily limited to, information available on social media platforms, web forums, and so forth (e.g., OSINT telescope data).

In some embodiments, quantitative data 116 can be derived to add additional data for a system 100 to ingest, e.g., using interpolation between existing data points. Such interpolations can be linear, polynomial, piecewise, and so forth.

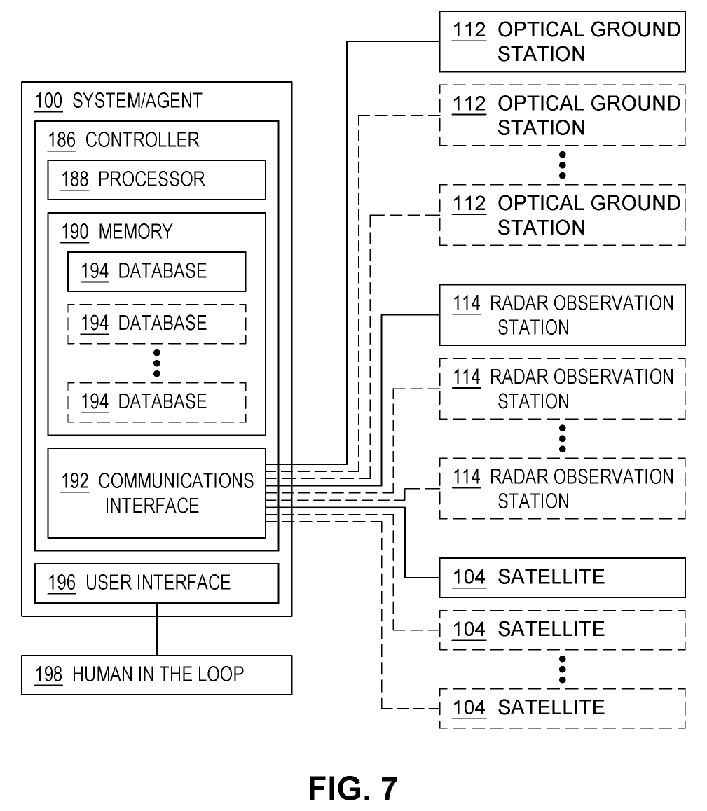

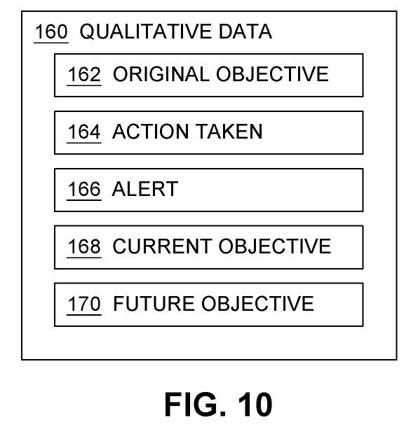

A system 100 can also have a database 194 (FIG. 7) including qualitative data 160 associated with the object. The qualitative data 160 can include one or more of the following: an original objective 162 for an object (e.g., a satellite 104), an action taken 164 by an object, an alert 166 associated with an object, a current objective 168 for an object, and/or a future objective 170 for an object, e.g., as shown in FIG. 10. In some embodiments, a future objective 170 can be generated using an external simulation, a hierarchical plan, and so forth. In some embodiments, the qualitative data 160 can include a natural language description. For example, the system 100 can locate an identification key within a comma-separated value (CSV) electronic file, and attributes associated with the identification key can be extracted from the CSV file by the system 100 in a natural language format, e.g., as a non-formatted string.

The system 100 can further include a controller 186 (FIG. 7) configured to receive the quantitative data 116 from the sensors and the qualitative data 160 from the database(s) 194. Referring now to FIG. 1, the controller 186 can be configured to mechanistically generate a situational assessment 202 for an object based upon the quantitative data 116 and the qualitative data 160. For example, the controller 186 can be configured to mechanistically generate a situational assessment 202 for an object using one or more language learning models (e.g., using a language learning model 204, a language learning model 206, a language learning model 208, a language learning model 210, and so forth) that process the natural language description. For example, events 212 (e.g., qualitative data 160) are provided to the language learning model 204. The output of the language learning model 204 can be provided to the language learning model 206 along with measurements 214 (e.g., quantitative data 116). Outputs of the language learning model 206 are then provided to the language learning model 208. In embodiments, an output of the language learning model 206 can be described as a policy inference 216. Context 218, and possibly one or more policy inferences 216, can be provided to the language learning model 210, and the output of the language learning model 210 can be provided to the language learning model 208. The output of the language learning model 208 is the situational assessment 202.

The system 100 can also include a user interface 196. In some embodiments, the controller 186 can be configured to provide the situational assessment 202 for evaluation by a human operator (human in the loop 198) via the user interface 196, update the qualitative data 160 to include a clarification associated with the object if added by the human in the loop 198 via the user interface 196 in response to the situational assessment 202 (e.g., in the form an event 212 provided to the language learning model 204), and then regenerate the situational assessment 202 when the qualitative data 160 has been updated to include the clarification/event 212 from the human in the loop 198. In some embodiments, inputs to and/or outputs of the language learning model 206 in the form of state information 220 can also be provided by a system 100.

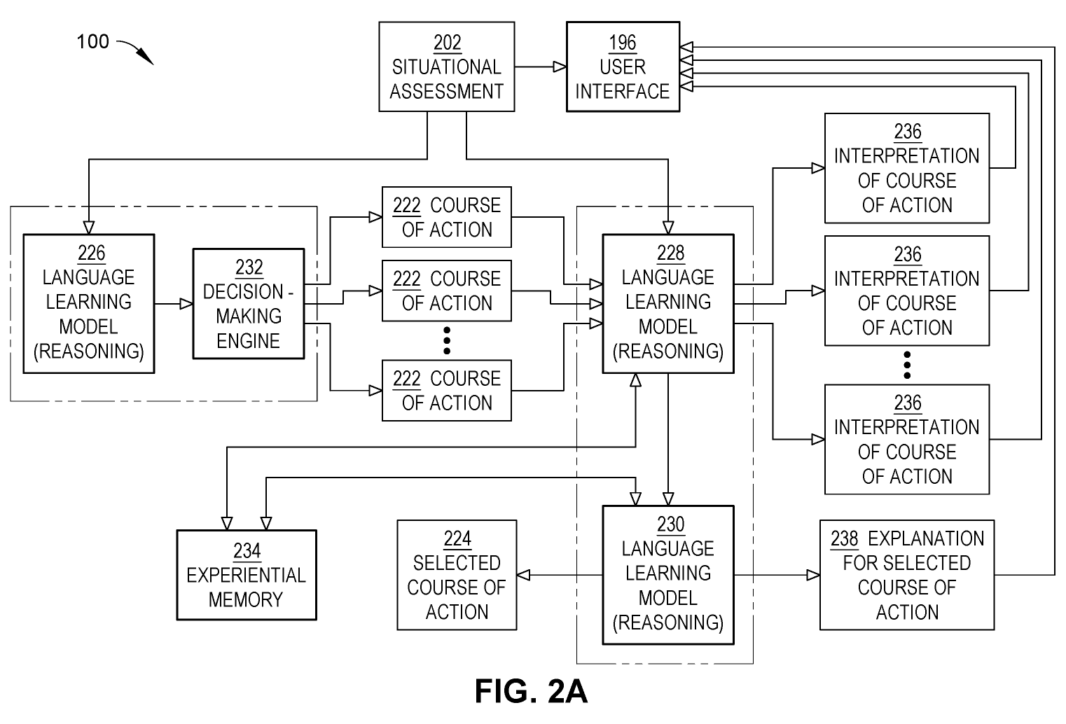

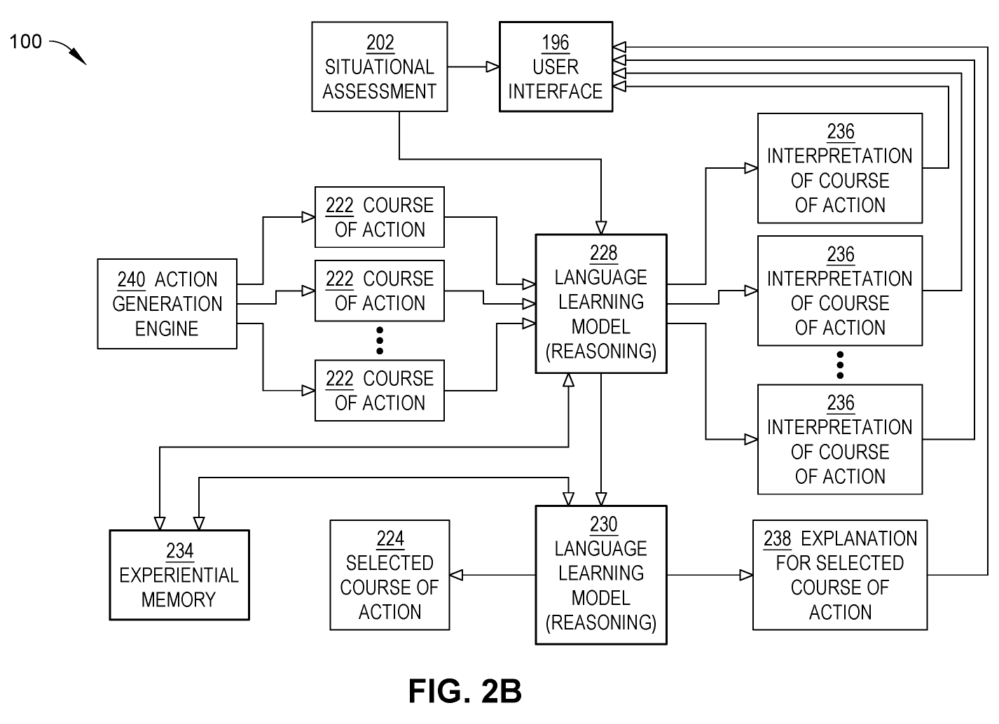

Referring now to FIG. 2A, a system 100 for selecting a course of action for at least one object in a collection of remote objects can have a database 194 including qualitative data 160 associated with the object. In some embodiments, an object in a collection of remote objects can be an orbital object. In an example, an object can be a controllable vehicle (e.g., a satellite 104).

The qualitative data 160 can include one or more of the following: an original objective 162 for an object, an action taken 164 by an object, an alert 166 associated with an object, a current objective 168 for an object, and/or a future objective 170 for an object, e.g., as shown in FIG. 10. In some embodiments, a future objective 170 can be generated using an external simulation, a hierarchical plan, and so forth. In some embodiments, the qualitative data 160 can include a natural language description. For example, the system 100 can locate an identification key within a comma-separated value (CSV) electronic file, and attributes associated with the identification key can be extracted from the CSV file by the system 100 in a natural language format, e.g., as a non-formatted string.

The system 100 can also include a controller 186 configured to receive a situational assessment 202 for the object, where the situational assessment 202 is based at least in part upon the qualitative data 160 associated with the object. The controller 186 can be configured to mechanistically generate multiple courses of action 222 based upon the situational assessment 202 and mechanistically select a course of action 224 from the courses of action 222. For example, the controller 186 can be configured to mechanistically generate courses of action 222 using a language learning model 226 and a decision-making engine 232 that process the situational assessment 202. The decision-making engine 232 can include, but is not necessarily limited to, a reinforcement learning model, a heuristic learning model, a Monte Carlo tree search (MCTS) model, a solver for decision-making, and so on. In some embodiments, the controller 186 can be configured to mechanistically select a course of action 224 from the multiple courses of action 222 using one or more language learning models that process the courses of action 222 (e.g., using a language learning model 228, a language learning model 230, and so forth).

For example, a situational assessment 202 is provided to the language learning model 226. The output of the language learning model 226 can be provided to the decision-making engine 232. In some embodiments, the decision-making engine 232 implements an MCTS model for simulation and planning purposes that can generate metrics for extended futures, e.g., where simulated actions have consequences that lead to different branches of a tree structure used for planning. In other embodiments, the decision-making engine 232 can be a reinforcement learning model. The outputs of the decision-making engine 232, in the form of courses of action 222, are provided to the language learning model 228 along with the situational assessment 202. The outputs of the language learning model 228 can be supplied to the language learning model 230. The outputs of the language learning model 228 and the language learning model 230 can also be supplied to an experiential memory 234. In some embodiments, outputs of the experiential memory 234 are provided to the language learning model 228 and/or the language learning model 230. It should be noted that language learning models and decision-making engines are provided by way of example and are not meant to limit the present disclosure. In other embodiments, different mechanistic generation techniques can be used, including, but not necessarily limited to, heuristic (e.g., rule based) techniques, reinforcement learning techniques, and so forth.

In this manner, the system 100 can identify and select a course of action 224 from a pool of candidate courses of action 222. For the purposes of the present disclosure, the term “course of action” shall be understood to refer to one or more individual actions. For example, a course of action 222, 224 can be a single action or multiple actions that form a group or sequence of actions. Thus, the term “course of action” shall be understood to refer to a single action, a group or collection of actions, a sequence of actions, and so forth.

In some embodiments, a course of action 222, 224 can be a linear group or sequence of actions (action A, action B, action C, and so forth). In some examples, actions or sub-groups of actions in a linear group or sequence of actions can be performed in a pre-specified order, e.g., when strict sequential execution of at least some actions is desired to meet pre-specified objectives. However, when a group or sequence of actions does not necessitate strict sequential execution, some actions or sub-groups of actions may be performed in various non-sequential orders. In still further examples, priorities can be given to preferentially order actions or sub-groups of actions within a group or sequence of actions, but actions or sub-groups of actions may still be indicated as permissible for performance “out of order” if needed to complete execution of a course of action 222, 224.

In some embodiments, a sequence of actions can be a hierarchical set of actions. For example, a course of action 222, 224 can be defined as a hierarchical structure with connected nodes joined by edges or links. In some examples, a course of action 222, 224 can be an “action tree” having a root node with connected nodes branching from the root. However, a tree data structure is provided by way of example and is not meant to limit the present disclosure. In other embodiments, different hierarchical structures can be used by a system 100.

The system 100 can also include a user interface 196. In embodiments, the controller 186 can be configured to mechanistically generate multiple interpretations 236 based upon the situational assessment 202 and the courses of action 222, provide the interpretations 236 for evaluation by a human operator (human in the loop 198) via the user interface 196, and then update the situational assessment 202 with a clarification associated with the object if added by the human in the loop 198 via the user interface 196 in response to the interpretations 236 (e.g., a clarification in the form of an event 212 provided to a language learning model that generates a situational assessment 202 as described with reference to FIG. 1).

The controller 186 can also be configured to provide the selected course of action 224 for evaluation by a human in the loop 198 via the user interface 196 and update the situational assessment 202 with a clarification associated with an object if added by the human in the loop 198 via the user interface 196 in response to the selected course of action 224 (e.g., a clarification in the form of an event 212 provided to a language learning model that generates a situational assessment 202 as described with reference to FIG. 1). In some embodiments, the course of action 224 is provided to the human in the loop 198 along with an explanation 238 for the selected course of action 224. An example explanation 238 is, “I have chosen the ‘Establish an NMC with a minimum separation of 5.0 km around the target within a 12.2 hour time of flight’ operation because it aligns with the mission objectives by establishing a natural motion circumnavigation (NMC) with a minimum separation of 5.0 km around the target, which is within the desired distance range of 5.0 to 10.0 km. This operation also uses a minimal amount of fuel.”

Referring generally to FIG. 2B, a system 100, such as the system described with reference to FIG. 2A, does not necessarily use a situational assessment 202 to mechanistically generate courses of action 222. Instead, in some embodiments, a system 100 uses state information to generate courses of action 222, e.g., without using natural language or other supplemental data. For example, a system 100 includes an action generation engine 240 that uses state information (e.g., state information 220 for/from a language learning model 206 as described with reference to FIG. 1).

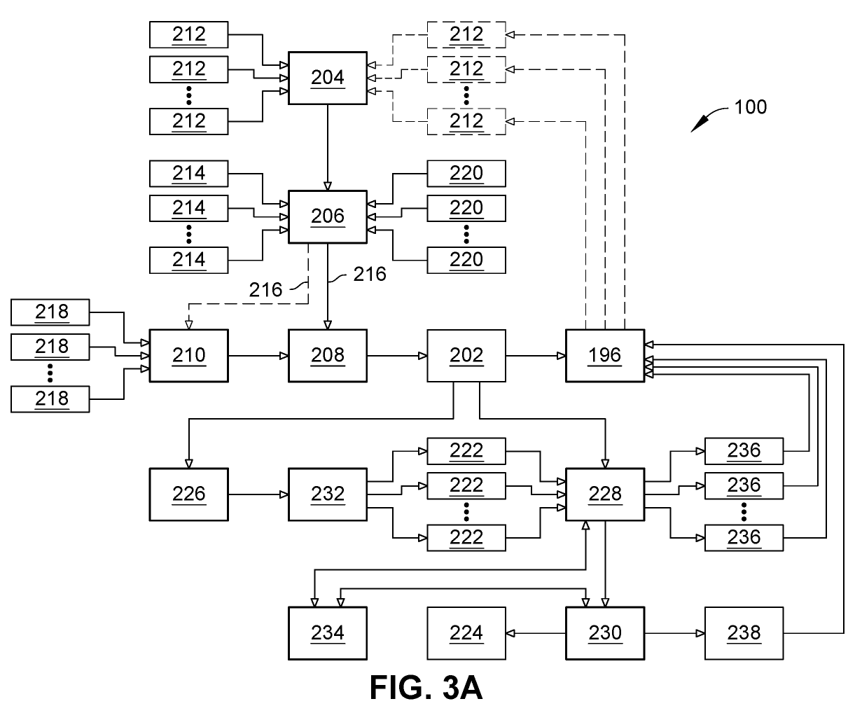

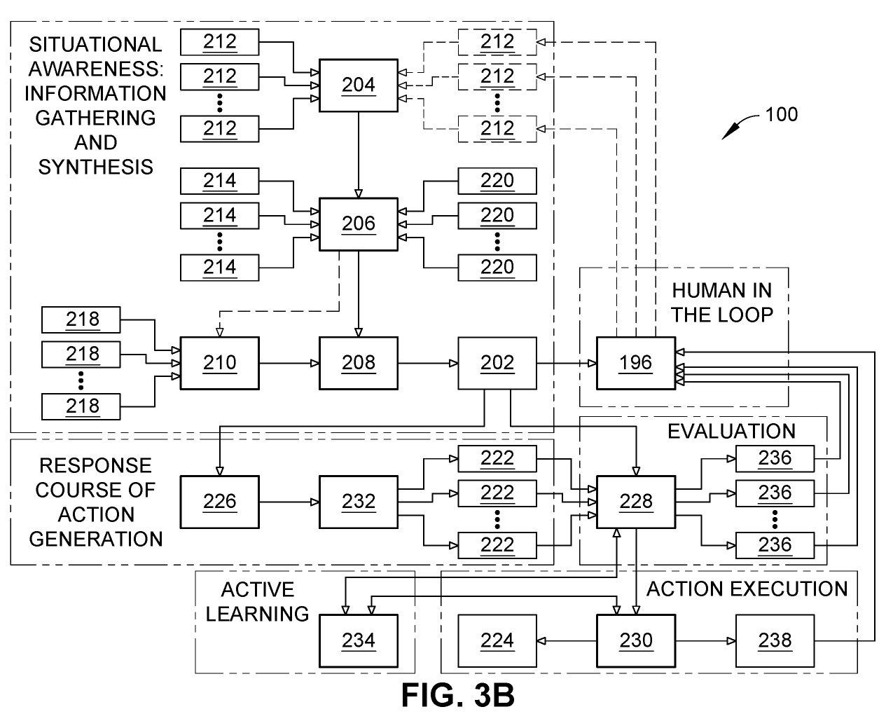

Referring now to FIGS. 3A and 3B, a system 100 for selecting a course of action for at least one object in a collection of remote objects can include sensors for remotely measuring quantitative data associated with the object. In some embodiments, an object in a collection of remote objects can be an orbital object. In an example, an object can be a controllable vehicle. For example, a system 100 can generate a course of action for one or more satellites 104 in a collection 106 of satellites. A system 100 can use sensors at optical ground stations 112, radar observation stations 114, satellites 104, and so on, to remotely measure the quantitative data, e.g., as shown in FIG. 8. In some embodiments, quantitative data 116 can be derived to add additional data for a system 100 to ingest, e.g., using interpolation between existing data points. Such interpolations can be linear, polynomial, piecewise, and so forth.

The system 100 can also have a database 194 (FIG. 7) including qualitative data 160 associated with the object. The qualitative data 160 can include one or more of the following: an original objective 162 for an object (e.g., a satellite 104), an action taken 164 by an object, an alert 166 associated with an object, a current objective 168 for an object, and/or a future objective 170 for an object, e.g., as shown in FIG. 10. In some embodiments, a future objective 170 can be generated using an external simulation, a hierarchical plan, and so forth. In some embodiments, the qualitative data 160 can include a natural language description. For example, the system 100 can locate an identification key within a comma-separated value (CSV) electronic file, and attributes associated with the identification key can be extracted from the CSV file by the system 100 in a natural language format, e.g., as a non-formatted string.

The system 100 can further include a controller 186 (FIG. 7) configured to receive the quantitative data 116 from the sensors and the qualitative data 160 from the database(s) 194. The controller 186 can be configured to mechanistically generate a situational assessment 202 for the object based upon the quantitative data 116 and the qualitative data 160. For example, the controller 186 can be configured to mechanistically generate a situational assessment 202 for an object using one or more language learning models (e.g., using a language learning model 204, a language learning model 206, a language learning model 208, a language learning model 210, and so forth) that process the natural language description. For example, events 212 (e.g., qualitative data 160) are provided to the language learning model 204. The output of the language learning model 204 can be provided to the language learning model 206 along with measurements 214 (e.g., quantitative data 116). Outputs of the language learning model 206 are then provided to the language learning model 208. In embodiments, an output of the language learning model 206 can be described as a policy inference 216. Context 218, and possibly one or more policy inferences 216, can be provided to the language learning model 210, and the output of the language learning model 210 can be provided to the language learning model 208. The output of the language learning model 208 is the situational assessment 202.

The system 100 can be configured to mechanistically generate multiple courses of action 222 based upon the situational assessment 202 and mechanistically select a course of action 224 from the courses of action 222. For example, the controller 186 can be configured to mechanistically generate courses of action 222 using a language learning model 226 and a decision-making engine 232 that process the situational assessment 202. The decision-making engine 232 can include, but is not necessarily limited to, a reinforcement learning model, a heuristic learning model, a Monte Carlo tree search (MCTS) model, a solver for decision-making, and so on. In some embodiments, the controller 186 can be configured to mechanistically select a course of action 224 from the multiple courses of action 222 using one or more language learning models that processes the courses of action 222 (e.g., using a language learning model 228, a language learning model 230, and so forth).

For example, a situational assessment 202 is provided to the language learning model 226. The output of the language learning model 226 can be provided to the decision-making engine 232. In some embodiments, the decision-making engine 232 implements an MCTS model for simulation and planning purposes that can generate metrics for extended futures, e.g., where simulated actions have consequences that lead to different branches of a tree structure used for planning. In other embodiments, the decision-making engine 232 can be a reinforcement learning model. The outputs of the decision-making engine 232, in the form of courses of action 222, are provided to the language learning model 228 along with the situational assessment 202. The outputs of the language learning model 228 can be supplied to the language learning model 230. The outputs of the language learning model 228 and the language learning model 230 can also be supplied to an experiential memory 234. In some embodiments, outputs of the experiential memory 234 are provided to the language learning model 228 and/or the language learning model 230. It should be noted that language learning models and decision-making engines are provided by way of example and are not meant to limit the present disclosure. In other embodiments, different mechanistic generation techniques can be used, including, but not necessarily limited to, heuristic (e.g., rule based) techniques, reinforcement learning techniques, and so forth. In this manner, the system 100 can identify and select a course of action 224 from a pool of candidate courses of action 222.

The system 100 can also include a user interface 196. In embodiments, the controller 186 can be configured to provide the situational assessment 202 for evaluation by a human operator (human in the loop 198) via the user interface 196, update the qualitative data 160 to include a clarification associated with the object if added by the human in the loop 198 via the user interface 196 in response to the situational assessment 202 (e.g., in the form an event 212 provided to the language learning model 204), and then regenerate the situational assessment 202 when the qualitative data 160 has been updated to include the clarification/event 212 from the human in the loop 198. In some embodiments, inputs to and/or outputs of the language learning model 206 in the form of state information 220 can also be provided by a system 100.

In embodiments, the controller 186 can be configured to mechanistically generate multiple interpretations 236 based upon the situational assessment 202 and the courses of action 222, provide the interpretations 236 for evaluation by a human in the loop 198 via the user interface 196, and then update the situational assessment 202 with a clarification associated with the object if added by the human in the loop 198 via the user interface 196 in response to the interpretations 236 (e.g., a clarification in the form of an event 212 provided to language learning model 204 that generates situational assessment 202).

The controller 186 can also be configured to provide the selected course of action 224 for evaluation by a human in the loop 198 via the user interface 196 and update the situational assessment 202 with a clarification associated with an object if added by the human in the loop 198 via the user interface 196 in response to the selected course of action 224 (e.g., a clarification in the form of an event 212 provided to language learning model 204 that generates situational assessment 202). In some embodiments, the course of action 224 is provided to the human in the loop 198 along with an explanation 238 for the selected course of action 224. An example explanation 238 is, “I have chosen the ‘Establish an NMC with a minimum separation of 5.0 km around the target within a 12.2 hour time of flight’ operation because it aligns with the mission objectives by establishing a natural motion circumnavigation (NMC) with a minimum separation of 5.0 km around the target, which is within the desired distance range of 5.0 to 10.0 km. This operation also uses a minimal amount of fuel.”

With reference to FIGS. 3A through 5, a system 100 can implement an observe-orient-decide-act (OODA) loop. For example, the system 100 is provided with quantitative data 116 and qualitative data 160 associated with a first satellite 104 and a second satellite 104 in a collection 106 of satellites. The system 100 determines multiple courses of action 222 for the first satellite 104 and/or the second satellite 104. Then, the system 100 selects a course of action 224 and provides contextual explainability (explanation 238) about the selected course of action. The system 100 then acts on the course of action 224 to implement the selected course of action, e.g., instructing the first satellite to wait, observe the second satellite, deploy equipment and/or instrumentation (e.g., solar panels, an antenna), intercept the second satellite, hide from the second satellite, retreat from the second satellite, avoid the second satellite, approach the second satellite, and so forth.

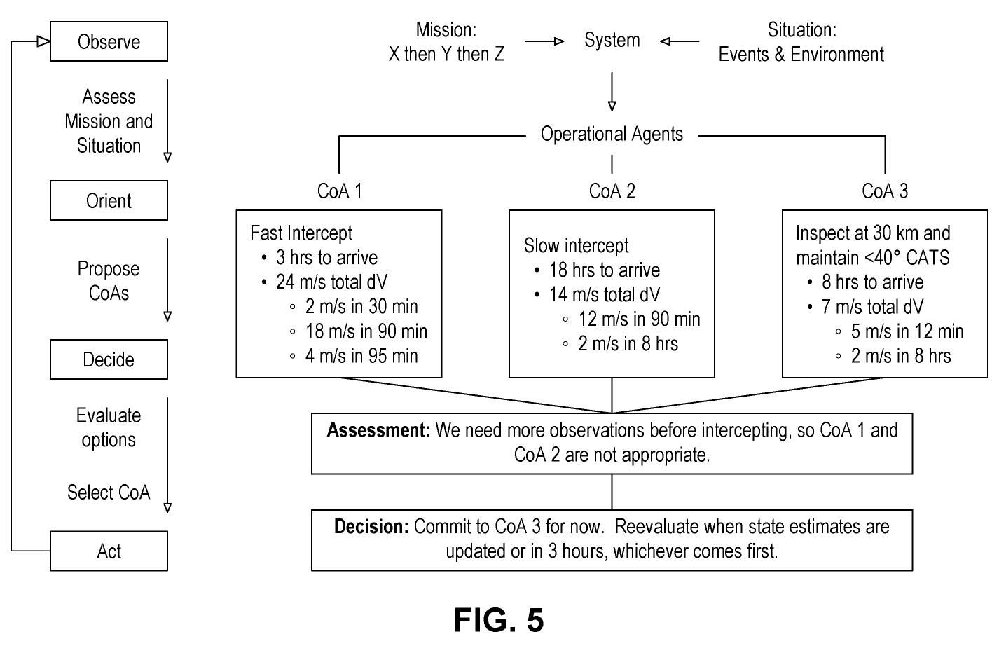

For example, as described with reference to FIG. 5, a system 100 observes to assess a mission and situation, orients to propose candidate courses of action, decides to evaluate options and select a course of action, and acts to implement the course of action. The system 100 can then return to an observational status and continue this process. In some embodiments, a mission evaluated by a system 100 can be a sequence of observations and/or actions expected or pre-determined to be performed in a specified order, e.g., if expected observation or action ‘X,’ then expected observation or action ‘Y,’ then expected observation or action ‘Z,’ and so forth. The situation evaluated by the system 100 can include events associated with the collection of objects and their environment, e.g., as determined by the system 100 using quantitative data 116 and qualitative data 160. In the present example, the system 100 determines three (3) separate courses of action: a first course of action (CoA 1) where the first satellite intercepts the second satellite in three (3) hours, a second course of action (CoA 2) where the first satellite intercepts the second satellite at a slower pace in eighteen (18) hours, and a third course of action (CoA 3) where the first satellite inspects the second satellite from a distance of thirty kilometers (30 km). Based upon an assessment that more observations are needed before the first satellite intercepts the second satellite, the system 100 determines CoA 1 and CoA 2 are not appropriate and selects CoA 3, planning to reevaluate when state estimates are updated or in three (3) hours, whichever comes first.

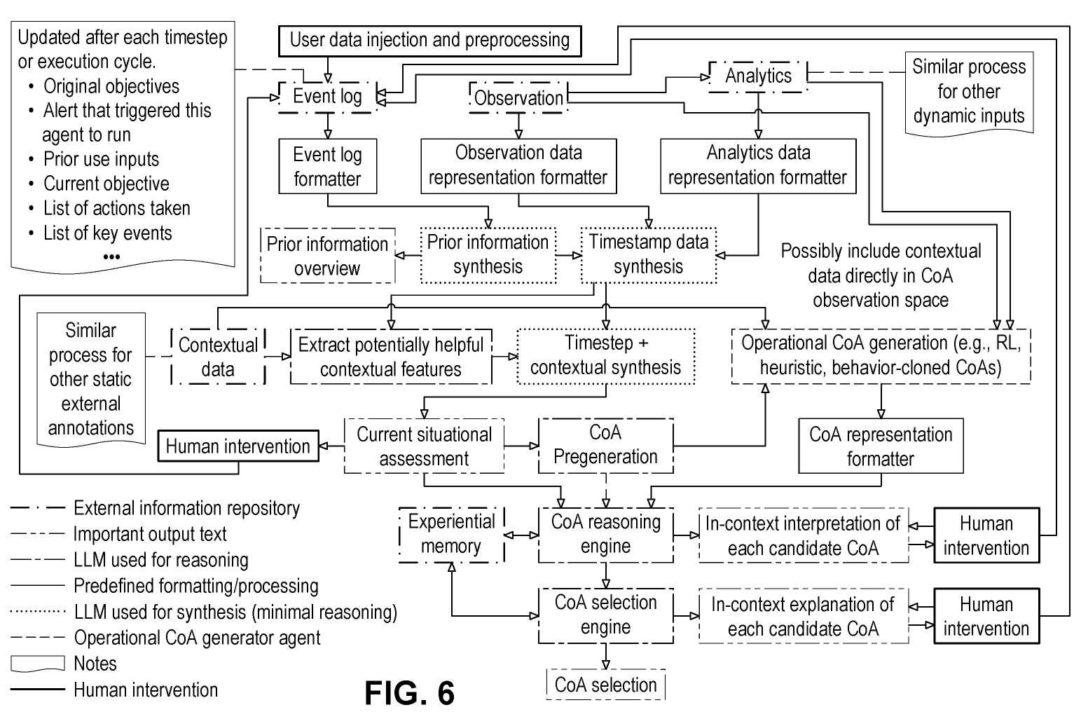

Referring now to FIG. 6, functionality for systems 100 that can synthesize input data for insights or actions is described, such as the systems 100 described with reference to FIGS. 1 through 3B. The systems described herein can operate autonomously (e.g., executing a course of action 224 when delegated) and, optionally, with human intervention. As described, the systems 100 can ingest current, recent, and historical data feeds. The data ingested by the systems 100 can be numerical, categorical, natural language, time-dependent, static, atemporal, and so forth. The data can include contextual information, annotations, analytics, and/or events. The data can also be tabular, free-form, and/or functional. The data can further be real-world data, synthetic data, and/or hybrid data.

The systems 100 described herein can deploy subsystems to format, merge, synthesize, summarize, and analyze data input streams. These subsystems can employ heuristic techniques, algorithmic techniques, probabilistic techniques, and/or language learning model (LLM) techniques. The systems 100 can generate situational assessments 202 grounded in data input streams. The situational assessments 202 can be generated using heuristic techniques, algorithmic techniques, probabilistic techniques, and/or LLM techniques.

The systems 100 can also deploy subsystems to generate candidate courses of action and then format, assess, reason about, decide, describe, and/or explain in context of upstream data. The candidate courses of action and associated information can be generated using heuristic techniques, algorithmic techniques, probabilistic techniques, and/or LLM techniques. The subsystems can use learned and/or inferred behaviors, e.g., via reinforcement learning (RL), inverse reinforcement learning (IRL), behavior cloning (BC), and so forth. The systems 100 can explore possible futures by simulation and/or predictive modeling, counterfactual situations, reflections on past experiences, and extrinsic knowledge to influence outputs. The systems 100 can also interact with users and physical systems, which may be simulated in some implementations, to carry out selected actions.

In some embodiments, a system 100 employs dynamic possible futures exploration, e.g., using a Monte Carlo tree search (MCTS) model at the decision-making engine 232 that processes the situational assessment 202 (e.g., in combination with the language learning model 226). The use of MCTS can provide quantitative, configurable, and explainable reasoning. For example, decision nodes can branch from state nodes in a time-ordered tree structure, where different courses of action 222 are used to project future states at multiple levels with respect to the flow of time. Metrics can be used to examine most-explored nodes versus less-explored nodes. In this manner, the system 100 can use a future explanation of a state to explore outcomes and update guesses.

In some examples, action nodes branch from a root state node of a search tree. The action nodes can then branch to future state nodes, which lead to other future action nodes, which lead to other future state nodes, and so forth, until each branch of the tree that starts at the root node ends at a predicted future outcome. Metrics can be used to classify the different nodes. For instance, action nodes that branch from the root node can be classified according to “most selected action,” “next most explored action,” “less explored actions,” and so forth. The most selected action can lead to “most frequent next state,” with other next states being less frequent. By examining the terminations of each of the various branches of the tree, “frequent terminal states” can be determined. The different possible futures and node classifications can be used to select a specific course of action 224 for execution by the system 100. For example, the most frequent state may lead to predicted futures where a target satellite navigates to evade another satellite just before arrival of the second satellite. The most selected action may be a navigational course for the second satellite to perform a maneuver using a fuel-efficient strategy and achieve a closer proximity to the target satellite. And less explored actions may lead to lower rewards. Frequent terminal states can include futures where there is a high intercept chance for the target satellite.

By analyzing the various branching futures, observations can be used to infer a policy guiding the behavior of an object that is not previously known to a system 100. For example, in the case of a collection of objects that includes satellites operated by an adversary, an adversarial policy can be inferred by a system based upon analysis of predicted branching futures and observations over time as more information is collected. A system 100 explores possible futures using current information, observes actual outcomes, and then updates guesses accordingly. In this manner, the shapes of belief distributions can change over time as the system learns and infers information about a particular collection of objects. It should be noted that an MCTS model is provided by way of example and is not meant to limit the present disclosure. In other embodiments, different techniques may be used by the decision-making engine 232 to dynamically explore possible futures, including, but not necessarily limited to: reinforcement learning (e.g., deep reinforcement learning), heuristic-based search methods, and so forth.

In embodiments, the systems 100 described herein can execute in an external (real or simulated) environment with independent actors influencing the quantitative data 116 and qualitative data 160 received by the systems 100. In some embodiments, the systems 100 can be fully autonomous. The systems, techniques, and apparatus described herein can repeatedly, autonomously re-evaluate and select new courses of action in the presence of the actors’ influences. As described, an abstracted interface can be provided where a system 100 or agent as described herein can select a course of action with accompanying natural language assessments, and then deliver that choice to an interface that autonomously transmits the selected actions for execution to a controllable vehicle (e.g., a satellite). In some embodiments, a human in the loop-type system 100 delivers the recommendations for human consideration, but the system is not necessarily connected to an external environment for executing courses of action.

In some embodiments, a system 100 facilitates user interaction that provides dynamic feedback to one or more of the language learning models. For example, an operator (e.g., human in the loop 198) can provide dynamic feedback to the language learning model 208, the language learning model 228, the language learning model 230, and so forth, e.g., via the user interface 196. The feedback from an operator can be used to tune the LLMs to more closely align with human preferences, mission parameters, and so forth.

In some embodiments, a system 100 can operate as an advisor and provide decision support, e.g., giving situational snapshots to a human operator. In other embodiments, a system 100 can operate autonomously or at least semi-autonomously, executing on mission objectives while providing periodic updates, dynamically replanning, recycling behaviors, and so forth. Alerts 166 can be provided to human operators and/or to one or more other electronic systems when a significant decision is made, a significant event or change in state is determined, etc. Such updates can be used for replanning, e.g., when a system 100 acts in an advisory capacity. Tactics, techniques, and procedures (TTP), or rules that govern planned actions, can be implemented by a system 100, and the consequences of specific TTP policies can be observed by the system and used to provide recommendations (e.g., to a human in the loop 198). For example, a system 100 can recommend a particular maneuver for a satellite to avoid a collision with another satellite. Doctrine/TPP for a system 100 can be created and/or assessed by monitoring the consequences of TTP policies and recommendations. In some embodiments, a system 100 can be delegated dynamic action plans for execution (behavior policies).

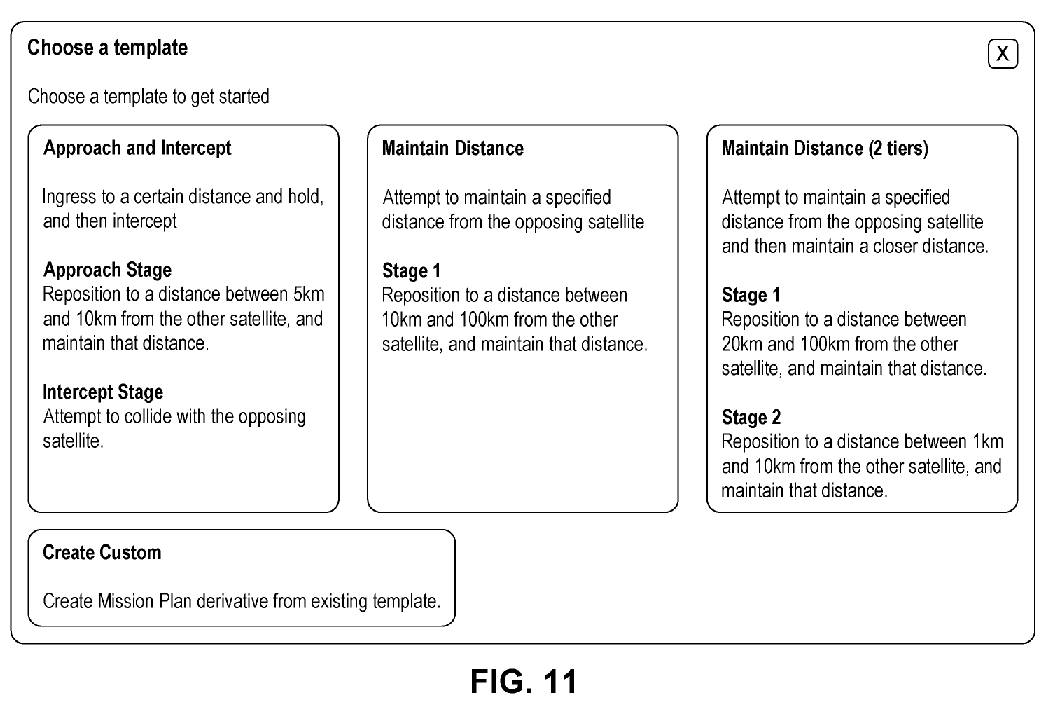

With reference to FIG. 11, a system 100 can implement a user interface 196 that provides an advisor mode for an operator (e.g., human in the loop). For example, the human advisor can be presented with several options (e.g., in the form of templates) for selecting a course of action. A first course of action can be to approach and intercept a target satellite. The operator can be presented with a description of the mission parameters for this first course of action, e.g., an approach stage, where a satellite controlled by the system 100 repositions to a distance or range from the target satellite and then maintains that distance, and an intercept stage, where the controlled satellite attempts to collide with the opposing satellite. Another course of action can be to maintain a particular distance from the target satellite, e.g., repositioning to a particular distance or range from the target satellite and then maintaining that distance. A further course of action can be multi-tiered, where the controlled satellite repositions to a particular distance or range from the target satellite at a first stage, and then repositions to a different (e.g., closer) distance or range from the target satellite at a second stage.

With reference to FIG. 7, a system 100, including some or all of its components, can operate under computer control. For example, one or more processors 188 can be included with or in a system 100 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

A processor 188 provides processing functionality for the system 100 and can include any number of processors, micro-controllers, or other processing systems, and resident or external memory for storing data and other information accessed or generated by the system 100. The processor 188 can execute one or more software programs that implement techniques described herein. The processor 188 is not limited by the materials from which it is formed or the processing mechanisms employed therein and, as such, can be implemented via semiconductor(s) and/or transistors (e.g., using electronic integrated circuit (IC) components), and so forth.

The system 100 includes one or more memories 190. A memory 190 is an example of tangible, computer-readable storage medium that provides storage functionality to store various data associated with operation of the system 100, such as software programs and/or code segments, or other data to instruct the processor 188, and possibly other components of the system 100, to perform the functionality described herein. Thus, the memory 190 can store data, such as a program of instructions for operating the system 100 (including its components), and so forth. It should be noted that while a single memory 190 is described, a wide variety of types and combinations of memory (e.g., tangible, non-transitory memory) can be employed. The memory 190 can be integral with the processor 188, can comprise stand-alone memory, or can be a combination of both.

The memory 190 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 190 can include removable integrated circuit card (ICC) memory, such as memory provided by a subscriber identity module (SIM) card, a universal subscriber identity module (USIM) card, a universal integrated circuit card (UICC), and so on.

In some embodiments, the memory 190 can store one or more databases 194 for use by the system 100 in generating a situational assessment 202 for at least one object in a collection of remote objects and/or for selecting a course of action for at least one object in a collection of remote objects. For example, the system 100 can have one or more databases 194 that store qualitative data 160, such as an original objective 162 for an object, an action taken 164 by an object, an alert 166 associated with an object, a current objective 168 for an object, a future objective 170 for an object, and so forth, e.g., as described with reference to FIG. 10. In some embodiments, the system 100 can have one or more databases 194 that store quantitative data 116, e.g., measurements from optical ground stations 112, radar observation stations 114, space-based observation stations (e.g., satellites 104), and so forth, e.g., as described with reference to FIG. 9.

The system 100 includes one or more communications interfaces 192. A communications interface 192 is operatively configured to communicate with components of the system 100 and is not necessarily connected to an external network. For example, the communications interface 192 can be configured to transmit data for storage in the system 100, retrieve data from storage in the system 100, and so forth. The communications interface 192 is also communicatively coupled with the processor 188 to facilitate data transfer between components of the system 100 and the processor 188 (e.g., for communicating inputs to the processor 188 received from a device communicatively coupled with the system 100). It should be noted that while the communications interface 192 is described as a component of a system 100, one or more components of the communications interface 192 can be implemented as external components communicatively coupled to the system 100 via a wired and/or wireless connection. The system 100 can also comprise and/or connect to one or more input/output (I/O) devices (e.g., via the communications interface 192), including, but not necessarily limited to: a display, a mouse, a touchpad, a keyboard, and so on.

The communications interface 192 and/or the processor 188 can be configured to communicate with a variety of different networks, including, but not necessarily limited to: a wide-area cellular telephone network, such as a 3G cellular network, a 4G cellular network, a 5G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 192 can be configured to communicate with a single network or multiple networks across different access points.

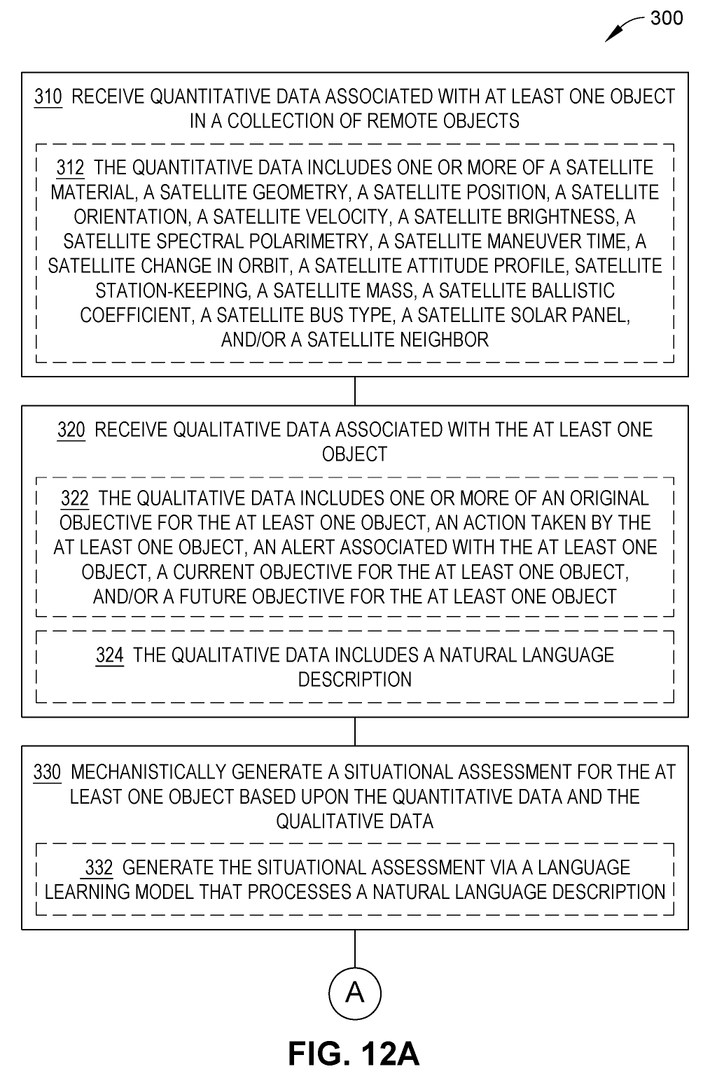

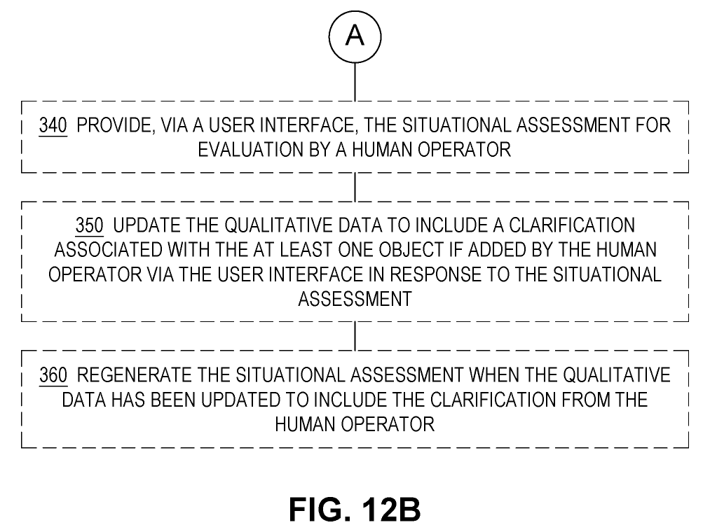

Referring now to FIGS. 12A and 12B, a process 300 for generating a situational assessment for at least one object in a collection of remote objects is depicted in accordance with example embodiments, e.g., as described with reference to the systems 100 discussed above with reference to FIG. 1. In some embodiments, an object in a collection of remote objects can be an orbital object. In an example, an object can be a controllable vehicle. For example, the object can be a satellite 104 in a collection 106 of satellites.

In the process illustrated, quantitative data associated with the object is received (Block 310). In some embodiments, the quantitative data can be one or more of a satellite material, a satellite geometry, a satellite position, a satellite orientation, a satellite velocity, a satellite brightness, a satellite spectral polarimetry, a satellite maneuver time, a satellite change in orbit, a satellite attitude profile, satellite station-keeping, a satellite mass, a satellite ballistic coefficient, a satellite bus type, a satellite solar panel, and/or a satellite neighbor (Block 312). For example, a system 100 receives quantitative data 116 as described with reference to FIG. 9.

Qualitative data associated with the object is also received (Block 320). The qualitative data can include one or more of the following: an original objective for an object, an action taken by an object, an alert associated with an object, a current objective for an object, and/or a future objective for an object (Block 322). For instance, a system 100 receives qualitative data 160 as described with reference to FIG. 10. In some embodiments, the qualitative data can include a natural language description (Block 324). For example, a system 100 locates an identification key within a comma-separated value (CSV) electronic file, and attributes associated with the identification key are extracted from the CSV file by the system 100 as a non-formatted string.

Then, a situational assessment is mechanistically generated for the object based upon the quantitative data and the qualitative data (Block 330). For example, a situational assessment 202 is generated that indicates, “This course of action, ingress to perch with 5.0 km distance within a 6.2 hour time of flight, aligns with the mission objectives by maintaining a distance between 5.0 and 10.0 km from the target satellite and not intercepting it. The fuel used, 1.79 m/s, is well within the 100.0 m/s limit, which is a significant positive aspect. However, the time required, 6.2 hours, may be a negative aspect.” In some embodiments, the situational assessment is mechanistically generated for the object using a language learning model that processes the natural language description (Block 332). For instance, controller 186 mechanistically generates a situational assessment 202 for an object using one or more language learning models (e.g., using language learning model 204, language learning model 206, language learning model 208, language learning model 210, and so forth) that process the natural language description.

In some embodiments, the situational assessment can be provided for evaluation by a human operator via a user interface (Block 340). For example, a situational assessment 202 is provided to a human in the loop via the user interface 196. The qualitative data can be updated to include a clarification associated with the object if added by the human operator via the user interface in response to the situational assessment (Block 350). For instance, an operator provides clarification via the user interface 196 in the form of an event 212 that is used to update the qualitative data 160. Then, the situational assessment can be regenerated when the qualitative data has been updated to include the clarification from the human operator (Block 360). For example, a new situational assessment 202 is generated by the system 100.

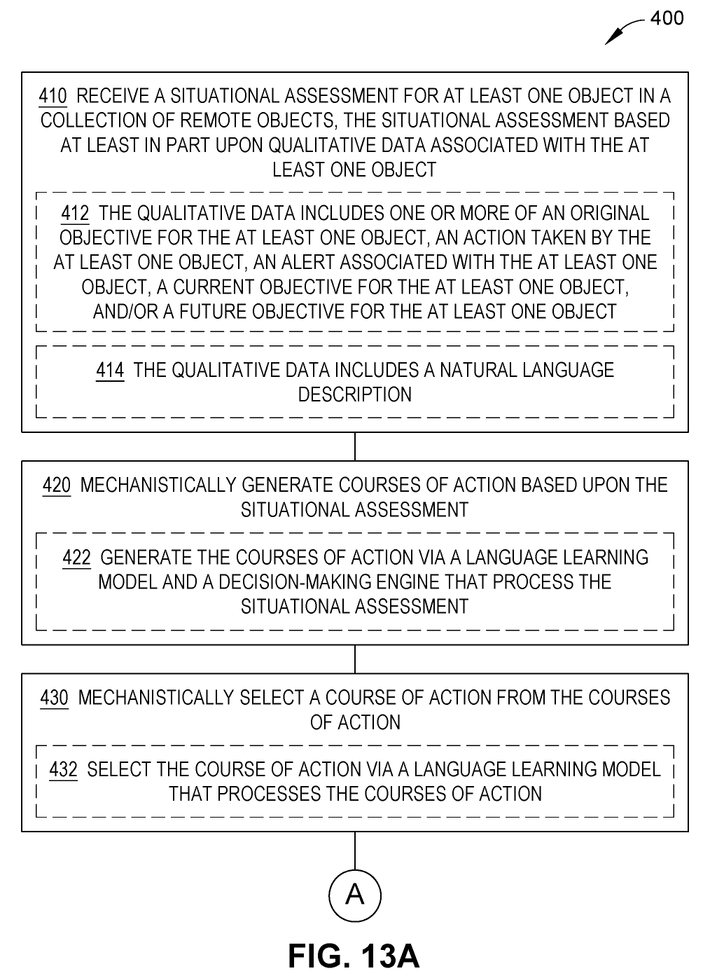

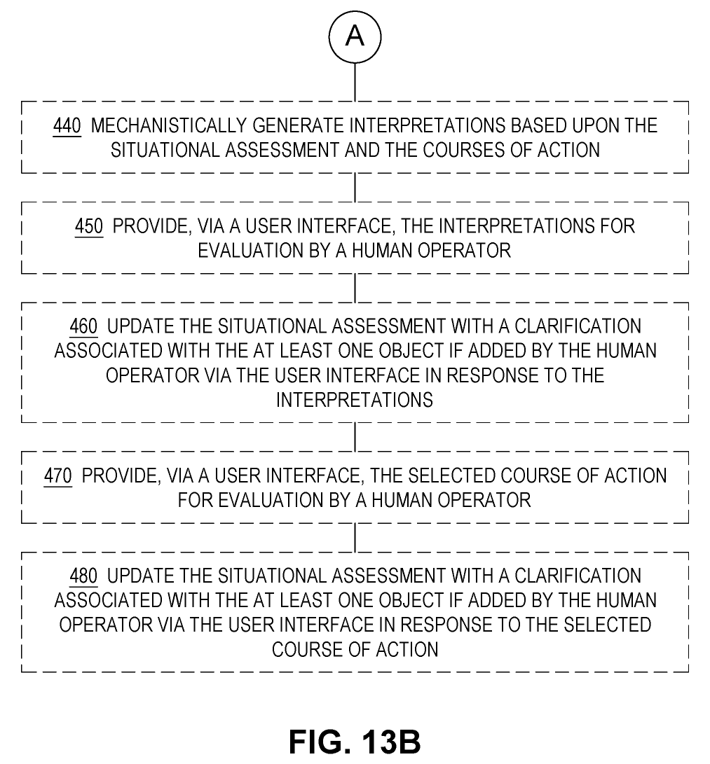

Referring now to FIGS. 13A and 13B, a process 400 for selecting a course of action for at least one object in a collection of remote objects is depicted in accordance with example embodiments, e.g., as described with reference to the systems 100 discussed above with reference to FIGS. 2A and 2B. In some embodiments, an object in a collection of remote objects can be an orbital object. In an example, an object can be a controllable vehicle. For example, the object can be a satellite 104 in a collection 106 of satellites.

In the process illustrated, a situational assessment is received for the object, where the situational assessment is based at least in part upon qualitative data associated with the object (Block 410). For example, a situational assessment 202 is received that indicates, “This course of action, ingress to perch with 5.0 km distance within a 6.2 hour time of flight, aligns with the mission objectives by maintaining a distance between 5.0 and 10.0 km from the target satellite and not intercepting it. The fuel used, 1.79 m/s, is well within the 100.0 m/s limit, which is a significant positive aspect. However, the time required, 6.2 hours, may be a negative aspect.” The qualitative data can include one or more of the following: an original objective for an object, an action taken by an object, an alert associated with an object, a current objective for an object, and/or a future objective for an object (Block 412). For instance, a system 100 receives qualitative data 160 as described with reference to FIG. 10. In some embodiments, the qualitative data can include a natural language description (Block 414). For example, a system 100 locates an identification key within a comma-separated value (CSV) electronic file, and attributes associated with the identification key are extracted from the CSV file by the system 100 as a non-formatted string.

Then, courses of action are mechanistically generated based upon the situational assessment (Block 420). For example, a system 100 generates a first course of action 222 where a first satellite intercepts a second satellite in three (3) hours, a second course of action 222 where the first satellite intercepts the second satellite at a slower pace in eighteen (18) hours, and a third course of action 222 where the first satellite inspects the second satellite from a distance of thirty kilometers (30 km). In some embodiments, the courses of action can be mechanistically generated using a language learning model and a decision-making engine that process the situational assessment (Block 422). For instance, as described with reference to FIG. 2A, a system 100 uses language learning model 226 and decision-making engine 232 to generate courses of action 222.

In some embodiments, the situational assessment is not necessarily used to mechanistically generate courses of action. Instead, state information can be used to generate courses of action, e.g., without the use of natural language or other supplemental data. For example, as described with reference to FIG. 2B, a system 100 uses action generation engine 240 with state information 220 for/from language learning model 206 (FIG. 1) to generate courses of action 222.

Next, a course of action is mechanistically selected from the courses of action (Block 430). For instance, based upon an assessment that more observations are needed before the first satellite intercepts the second satellite, the system 100 determines the first and second courses of action 222 are not appropriate and selects the third course of action, e.g., as described with reference to FIG. 5. In some embodiments, a course of action can be mechanistically selected from the multiple courses of action using a language learning model that processes the courses of action (Block 432). For example, controller 186 mechanistically selects course of action 224 (the third course of action 222) using one or more language learning models that process the courses of action 222 (e.g., using language learning model 228, language learning model 230, and so forth).

In some embodiments, multiple interpretations are mechanistically generated based upon the situational assessment and the courses of action (Block 440). For example, controller 186 generates multiple interpretations 236 based upon situational assessment 202 and courses of action 222. Next, the interpretations are provided for evaluation by a human operator via a user interface (Block 450). For instance, interpretations 236 are provided to human in the loop 198 via user interface 196. Then, the situational assessment can be updated with a clarification associated with the object if added by the human operator via the user interface in response to the interpretations (Block 460). For example, a clarification in the form of an event 212 is provided to a language learning model that generates situational assessment 202 (FIG. 1).

In some embodiments, the selected course of action can be provided for evaluation by a human operator via the user interface (Block 470). For instance, selected course of action 224 is provided to human in the loop 198 via user interface 196. Next, the situational assessment can be updated with a clarification associated with an object if added by the human operator via the user interface in response to the selected course of action (Block 480). For example, a clarification in the form of an event 212 is provided to a language learning model that generates situational assessment 202 (FIG. 1).

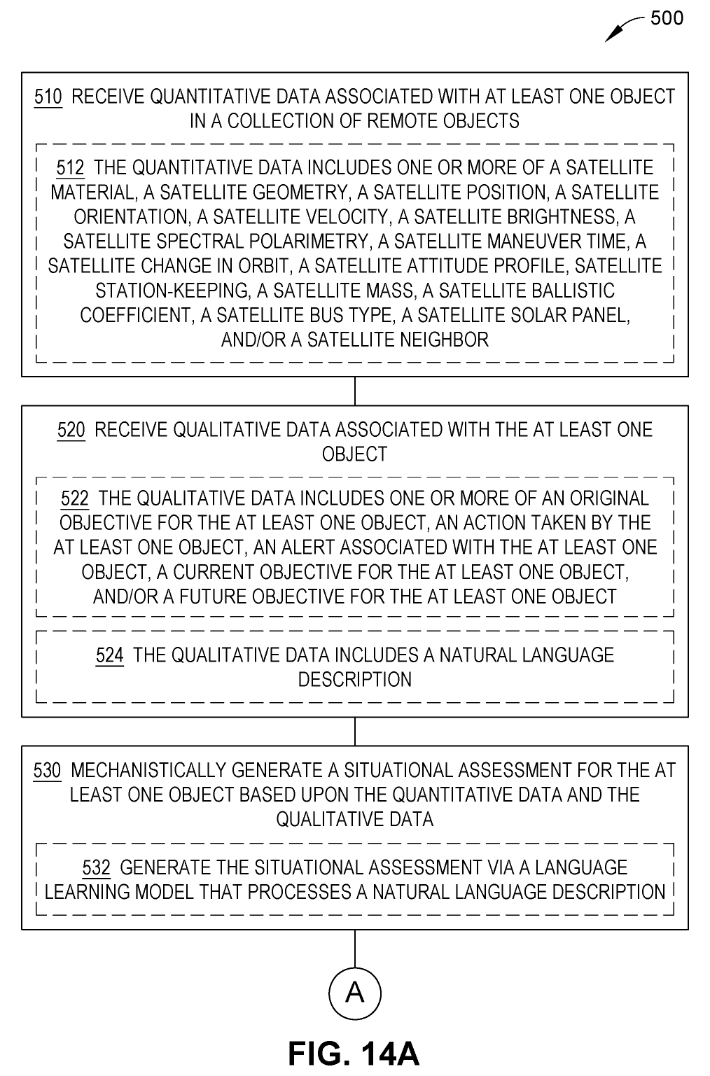

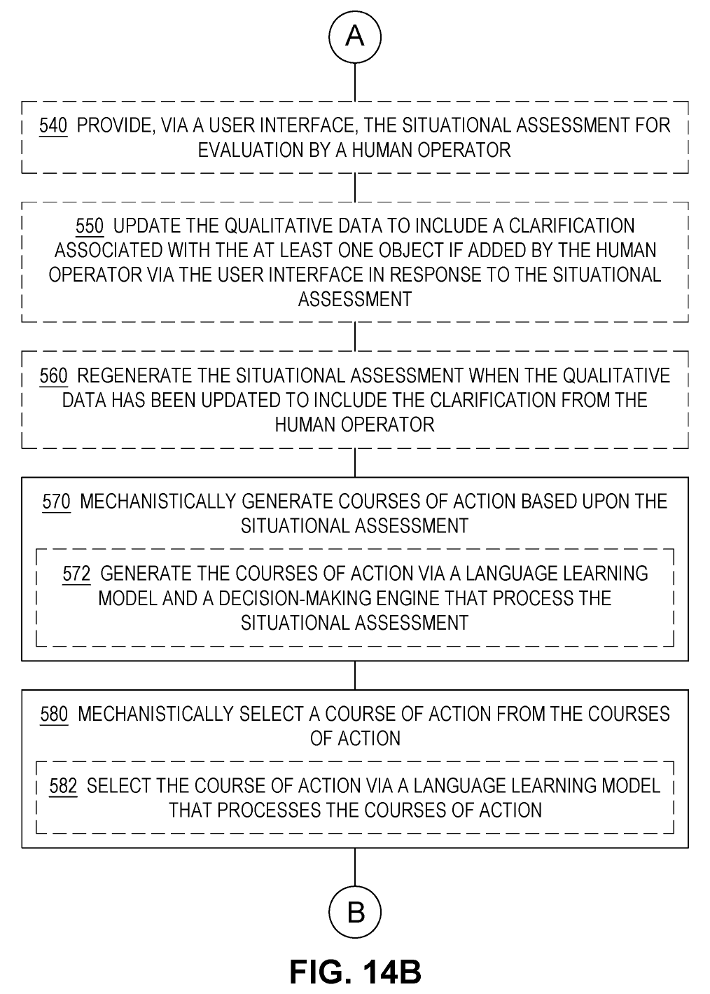

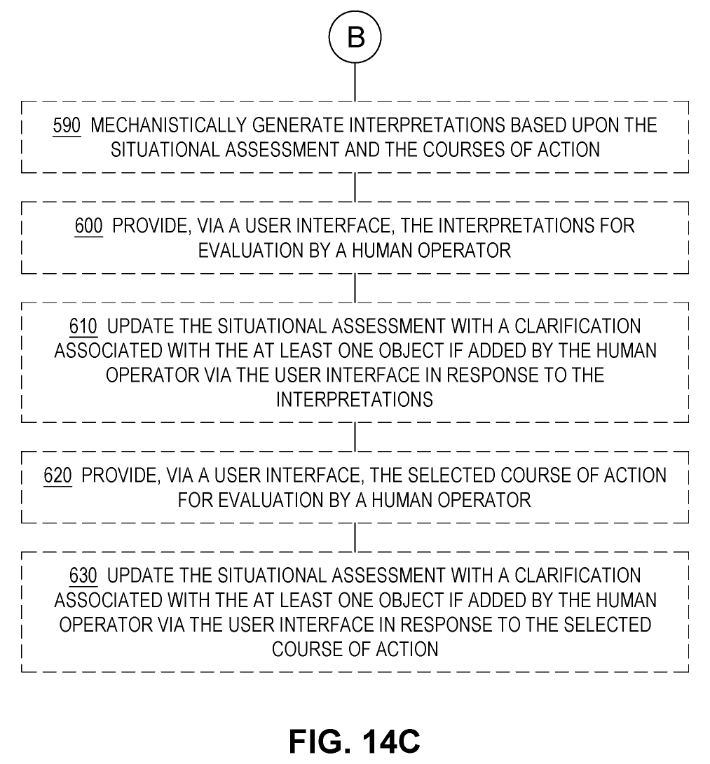

Referring now to FIGS. 14A through 14C, a process 500 for selecting a course of action for at least one object in a collection of remote objects is depicted in accordance with example embodiments, e.g., as described with reference to the systems discussed above with reference to FIGS. 3A and 3B. In some embodiments, an object in a collection of remote objects can be an orbital object. In an example, an object can be a controllable vehicle. For example, the object can be a satellite 104 in a collection 106 of satellites.

In the process illustrated, quantitative data associated with the object is received (Block 510). In some embodiments, the quantitative data can be one or more of a satellite material, a satellite geometry, a satellite position, a satellite orientation, a satellite velocity, a satellite brightness, a satellite spectral polarimetry, a satellite maneuver time, a satellite change in orbit, a satellite attitude profile, satellite station-keeping, a satellite mass, a satellite ballistic coefficient, a satellite bus type, a satellite solar panel, and/or a satellite neighbor (Block 512). For example, a system 100 receives quantitative data 116 as described with reference to FIG. 9.

Qualitative data associated with the object is also received (Block 520). The qualitative data can include one or more of the following: an original objective for an object, an action taken by an object, an alert associated with an object, a current objective for an object, and/or a future objective for an object (Block 522). For instance, a system 100 receives qualitative data 160 as described with reference to FIG. 10. In some embodiments, the qualitative data can include a natural language description (Block 524). For example, a system 100 locates an identification key within a comma-separated value (CSV) electronic file, and attributes associated with the identification key are extracted from the CSV file by the system 100 as a non-formatted string.

Then, a situational assessment is mechanistically generated for the object based upon the quantitative data and the qualitative data (Block 530). For example, a situational assessment 202 is generated that indicates, “This course of action, ingress to perch with 5.0 km distance within a 6.2 hour time of flight, aligns with the mission objectives by maintaining a distance between 5.0 and 10.0 km from the target satellite and not intercepting it. The fuel used, 1.79 m/s, is well within the 100.0 m/s limit, which is a significant positive aspect. However, the time required, 6.2 hours, may be a negative aspect.” In some embodiments, the situational assessment is mechanistically generated for the object using a language learning model that processes the natural language description (Block 532). For instance, controller 186 mechanistically generates a situational assessment 202 for an object using one or more language learning models (e.g., using language learning model 204, language learning model 206, language learning model 208, language learning model 210, and so forth) that process the natural language description.

In some embodiments, the situational assessment can be provided for evaluation by a human operator via a user interface (Block 540). For example, a situational assessment 202 is provided to a human in the loop via the user interface 196. The qualitative data can be updated to include a clarification associated with the object if added by the human operator via the user interface in response to the situational assessment (Block 550). For instance, an operator provides clarification via the user interface 196 in the form of an event 212 that is used to update the qualitative data 160. Then, the situational assessment can be regenerated when the qualitative data has been updated to include the clarification from the human operator (Block 560). For example, a new situational assessment 202 is generated by the system 100.

Then, courses of action are mechanistically generated based upon the situational assessment (Block 570). For example, a system 100 generates a first course of action 222 where a first satellite intercepts a second satellite in three (3) hours, a second course of action 222 where the first satellite intercepts the second satellite at a slower pace in eighteen (18) hours, and a third course of action 222 where the first satellite inspects the second satellite from a distance of thirty kilometers (30 km). In some embodiments, the courses of action can be mechanistically generated using a language learning model and a decision-making engine that process the situational assessment (Block 572). For instance, a system 100 uses language learning model 226 and decision-making engine 232 to generate courses of action 222.

In some embodiments, the situational assessment is not necessarily used to mechanistically generate courses of action. Instead, state information can be used to generate courses of action, e.g., without the use of natural language or other supplemental data. For example, a system 100 uses action generation engine 240 (FIG. 2B) with state information 220 for/from language learning model 206 to generate courses of action 222.

Next, a course of action is mechanistically selected from the courses of action (Block 580). For instance, based upon an assessment that more observations are needed before the first satellite intercepts the second satellite, the system 100 determines the first and second courses of action 222 are not appropriate and selects the third course of action, e.g., as described with reference to FIG. 5. In some embodiments, a course of action can be mechanistically selected from the multiple courses of action using a language learning model that processes the courses of action (Block 582). For example, controller 186 mechanistically selects course of action 224 (the third course of action 222) using one or more language learning models that process the courses of action 222 (e.g., using language learning model 228, language learning model 230, and so forth).

In some embodiments, multiple interpretations are mechanistically generated based upon the situational assessment and the courses of action (Block 590). For example, controller 186 generates multiple interpretations 236 based upon situational assessment 202 and courses of action 222. Next, the interpretations are provided for evaluation by a human operator via a user interface (Block 600). For instance, interpretations 236 are provided to human in the loop 198 via user interface 196. Then, the situational assessment can be updated with a clarification associated with the object if added by the human operator via the user interface in response to the interpretations (Block 610). For example, a clarification in the form of an event 212 is provided to language learning model 204 that generates situational assessment 202.

In some embodiments, the selected course of action can be provided for evaluation by a human operator via the user interface (Block 620). For instance, selected course of action 224 is provided to human in the loop 198 via user interface 196. Next, the situational assessment can be updated with a clarification associated with an object if added by the human operator via the user interface in response to the selected course of action (Block 630). For example, a clarification in the form of an event 212 is provided to a language learning model that generates situational assessment 202.

It should be noted that while the systems, techniques, and apparatus herein have been described in relation to techniques for generating situational assessments and selecting courses of action for interacting with environments where information can be gathered for collections of remote objects, such as satellites, these systems, techniques, and apparatus may also be used to generate situational assessments and select courses of action in other applications, including, but not necessarily limited to: genomics applications, biomedicine applications, agricultural applications, healthcare applications, electrical power grid applications, communication pattern applications, complex system health applications, maritime applications, and so forth. Further, the systems, techniques, and apparatus described herein can be used for training operators (human operators, AI operators, etc.).

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for selecting a course of action for at least one object in a collection of remote objects, the system comprising:
a plurality of sensors for remotely measuring quantitative data associated with the at least one object;
a database including qualitative data associated with the at least one object; and
a controller configured to
receive the quantitative data from the plurality of sensors,
receive the qualitative data from the database,
mechanistically generate a situational assessment for the at least one object based upon the quantitative data and the qualitative data,
mechanistically generate a plurality of courses of action based upon the situational assessment, and
mechanistically select a course of action from the plurality of courses of action.

2. The system as recited in claim 1, wherein the qualitative data includes at least one of:
an original objective for the at least one object,
an action taken by the at least one object,
an alert associated with the at least one object,
a current objective for the at least one object, or
a future objective for the at least one object.

3. The system as recited in claim 1, wherein the qualitative data includes a natural language description, and the controller is configured to mechanistically generate a situational assessment for the at least one object based upon the quantitative data and the qualitative data via a language learning model that processes the natural language description.

4. The system as recited in claim 1, further comprising a user interface, wherein the controller is configured to
provide, via the user interface, the situational assessment for evaluation by a human operator,
update the qualitative data to include a clarification associated with the at least one object if added by the human operator via the user interface in response to the situational assessment, and
regenerate the situational assessment when the qualitative data has been updated to include the clarification from the human operator.

5. The system as recited in claim 1, wherein the controller is configured to mechanistically generate a plurality of courses of action based upon the situational assessment via a language learning model and a decision-making engine that process the situational assessment.

6. The system as recited in claim 5, wherein the decision-making engine comprises at least one of a reinforcement learning model, a heuristic learning model, a Monte Carlo tree search (MCTS) model, or a solver.

7. The system as recited in claim 1, further comprising a user interface, wherein the controller is configured to
mechanistically generate a plurality of interpretations based upon the situational assessment and the plurality of courses of action,
provide, via the user interface, the plurality of interpretations for evaluation by a human operator, and
update the situational assessment with a clarification associated with the at least one object if added by the human operator via the user interface in response to the plurality of interpretations.

8. The system as recited in claim 1, wherein the controller is configured to mechanistically select a course of action from the plurality of courses of action by selecting the course of action via a language learning model that processes the plurality of courses of action.

9. The system as recited in claim 1, further comprising a user interface, wherein the controller is configured to
provide, via the user interface, the selected course of action for evaluation by a human operator, and
update the situational assessment with a clarification associated with the at least one object if added by the human operator via the user interface in response to the selected course of action.

10. A method of selecting a course of action for at least one object in a collection of remote objects, the method comprising:
receiving quantitative data associated with the at least one object;
receiving qualitative data associated with the at least one object;
mechanistically generating a situational assessment for the at least one object based upon the quantitative data and the qualitative data;
mechanistically generating a plurality of courses of action based upon the situational assessment; and
mechanistically selecting a course of action from the plurality of courses of action.

11. The method as recited in claim 10, wherein the qualitative data includes at least one of:
an original objective for the at least one object,
an action taken by the at least one object,
an alert associated with the at least one object,
a current objective for the at least one object, or
a future objective for the at least one object.

12. The method as recited in claim 10, wherein the qualitative data includes a natural language description, and mechanistically generating a situational assessment for the at least one object based upon the quantitative data and the qualitative data comprises generating the situational assessment via a language learning model that processes the natural language description.

13. The method as recited in claim 10, further comprising:
providing, via a user interface, the situational assessment for evaluation by a human operator;
updating the qualitative data to include a clarification associated with the at least one object if added by the human operator via the user interface in response to the situational assessment; and
regenerating the situational assessment when the qualitative data has been updated to include the clarification from the human operator.

14. The method as recited in claim 10, wherein mechanistically generating a plurality of courses of action based upon the situational assessment comprises generating the plurality of courses of action via a language learning model and a decision-making engine that process the situational assessment.

15. The method as recited in claim 14, wherein the decision-making engine comprises at least one of a reinforcement learning model, a heuristic learning model, a Monte Carlo tree search (MCTS) model, or a solver.

16. The method as recited in claim 10, further comprising:
mechanistically generating a plurality of interpretations based upon the situational assessment and the plurality of courses of action;
providing, via a user interface, the plurality of interpretations for evaluation by a human operator; and
updating the situational assessment with a clarification associated with the at least one object if added by the human operator via the user interface in response to the plurality of interpretations.

17. The method as recited in claim 10, wherein mechanistically selecting a course of action from the plurality of courses of action comprises selecting the course of action via a language learning model that processes the plurality of courses of action.

18. The method as recited in claim 10, further comprising:
providing, via a user interface, the selected course of action for evaluation by a human operator; and
updating the situational assessment with a clarification associated with the at least one object if added by the human operator via the user interface in response to the selected course of action.

19. A system for selecting a course of action for at least one object in a collection of remote objects, the system comprising:
a plurality of sensors for remotely measuring quantitative data associated with the at least one object;
one or more databases configured to store the quantitative data associated with the at least one object and qualitative data associated with the at least one object;
one or more processors; and
one or more memories having computer executable instructions stored thereon, the computer executable instructions configured for execution by the one or more processors to:
mechanistically generate a situational assessment for the at least one object based upon the quantitative data and the qualitative data,
mechanistically generate a plurality of courses of action based upon the situational assessment, and
mechanistically select a course of action from the plurality of courses of action.

20. The system as recited in claim 19, wherein the qualitative data includes at least one of:
an original objective for the at least one object,
an action taken by the at least one object,
an alert associated with the at least one object,
a current objective for the at least one object, or
a future objective for the at least one object.
